(19) United States
(12) Patent Application Publication
(10) Pub. No.: US 2008/0231726 A1
(43) Pub. Date: Sep. 25, 2008

(54) APPARATUS AND METHOD FOR IMAGE COLOR CORRECTION IN A PORTABLE DEVICE

(75) Inventor: GEORGE C. JOHN, ARLINGTON HEIGHTS, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/690,487

(22) Filed: Mar. 23, 2007

(51) Int. Cl. H04N 9/73; H04N 1/46

(52) U.S. Cl. 348/223.1; 358/516

(57) ABSTRACT

A method and apparatus for image color correction in a portable device. A device 100 can include a housing 110, a first camera 120 coupled to the housing, the first camera configured to capture a first image 125, and a second camera 130 coupled to the housing, the second camera configured to capture a second image 135. The device can also include a controller 140 coupled to the first camera and the second camera, the controller configured to control the operations of the device. The device can further include an image correction module 150 coupled to the controller, the image correction module configured to set a white balance of the first image based on the second image captured by the second camera.

### BACKGROUND

1. Field

The present disclosure is directed to a method and apparatus for image color correction in a portable device. More particularly, the present disclosure is directed to automatic color correction of an image taken by a camera in a portable device having two cameras.

2. Description of Related Art

Presently, when a photographer takes a picture of a scene, the scene is illuminated by an illuminant. Different illuminants may be biased towards different ends of the color spectrum, such as red or blue. When taking pictures of scenes that have different illuminants, auto white balance (AWB) is a very challenging problem for digital and analog photography. The aim is to correct for the color bias caused by the scene illuminant by performing illuminant estimation on the captured image. Despite extensive research, current solutions are far from perfect. Some current systems use methods to estimate a scene illuminant based on scene analysis using a mathematical model. The success of these systems can depend on how well the model matches a given image. Older techniques for auto white balance can involve manually placing a reference color, such as white, in front of the camera. This can simplify the white balance problem because red green blue (RGB) gains would just need to be adjusted to match the known reference color.

Unfortunately, most of the complex auto white balance algorithms cannot be run in real time within the limited computing resources of portable mobile imaging systems, such as portable phone cameras. Poor optical quality, lack of light, and high noise levels due to small pixel size can further complicate illuminant estimation. Furthermore, prior solutions are not effective because image content is not previously known and the use of a reference color can be quite cumbersome.

### SUMMARY

A method and apparatus for image color correction in a portable device. A device can include a housing, a first camera coupled to the housing, the first camera configured to capture a first image, and a second camera coupled to the housing, the second camera configured to capture a second image. The device can also include a controller coupled to the first camera and the second camera, the controller configured to control the operations of the device. The device can further include an image correction module coupled to the controller, the image correction module configured to set a white balance of an image of the first camera based on the second image captured by the second camera.

### BRIEF DESCRIPTION OF THE DRAWINGS

The embodiments of the present disclosure will be described with reference to the following figures, wherein like numerals designate like elements, and wherein:

FIG. 1 is an exemplary illustration of a device according to one embodiment;

FIG. 2 is an exemplary block diagram of a wireless communication device according to one embodiment;

FIG. 3 is an exemplary flowchart illustrating the operation of a wireless communication device according to one embodiment; and

FIG. 4 is an exemplary flowchart illustrating the operation of a wireless communication device according to another embodiment.

### DETAILED DESCRIPTION

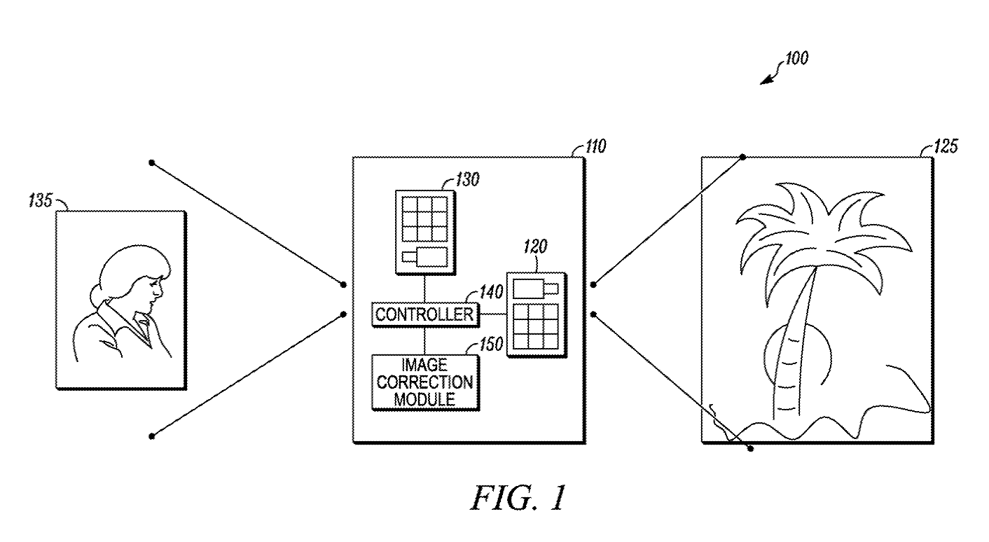

FIG. 1 is an exemplary illustration of a device 100 according to one embodiment. The device 100 can include a housing 110 and a first camera 120 coupled to the housing 110, the first camera 120 configured to capture a first image 125. The device 100 can also include a second camera 130 coupled to the housing 110, the second camera 130 configured to capture a second image 135. The device 100 can additionally include a controller 140 coupled to the first camera 120 and the second camera 130, the controller 140 configured to control the operations of the device 100. The device 100 can further include an image correction module 150 coupled to the controller 140, the image correction module 150 configured to set a white balance of the first camera 120 based on the second image 135 captured by the second camera 130.

For example, the device 100 may be a mobile phone or other electronic device that includes two cameras. One camera may face the user for self-portraits, video conferencing, or the like. The other camera may face away from the user for photographs, movies, or the like. Thus, the device 100 can use a primary camera, such as the first camera 120, for image capture. When using the first camera 120 for image capture the second camera 130 can point towards the user of the device 100. The device 100 can use object recognition on images from the second camera 135 to identify an object of known color and use that information to set the white balance for the first camera 120. According to a related embodiment, the second camera 130 that points towards the user can use object identification/recognition algorithms to identify the face of the user capturing the image and extract skin color information. For example, skin color falls within a limited gamut that can be easily extracted and used. In an additional related embodiment, the user's skin tone can be pre-stored in an imaging system in the device 100. The pre-stored skin tone information, or the limited skin color gamut information can then be used in estimating the illuminant from the observed skin color. The illuminant can be the primary illumination color in the scene of the image 125 being captured. For example, if the illuminant is reddish, the picture will have a red bias, and the device 100 can correct the image captured by the first camera 120 accordingly.

Thus, an image 135 from the second camera 130 can be processed through object recognition algorithms to identify objects of known color, and if identified, the observed color of the object in the image can be compared against stored information about the object color to estimate the scene illuminant and perform auto white balance for the first camera 120. The device 100 accordingly uses the second camera 130 to compute the scene illuminant, by recognizing objects present in the scene, whose color is known. In a mobile imaging device that often has the second camera 130 pointing towards the user of the device, there is an extremely high probability that the user's face is present in images captured from the second camera 130. The user can either pre-program his/her own skin tone for accurate illuminant estimation or use information about the human skin color gamut to estimate the illuminant to adjust the white balance.

For example, adjusting the white balance, such as Automatic White Balance (AWB) can be the process of estimating the predominant illuminant in a scene and correcting for it so that white objects appear white. The human brain renders colors based on ambient illumination, so we still see white objects as very close to white in different light conditions. Because a camera does not do this, we can correct images for the color bias due to illumination.

As a further example, in a digital camera, there are red, green and blue (R,G,B) pixels, and the color is computed based on the ratio of R, G and B. One way to do the white balance is to vary the gain on the different color pixels. For example, under incandescent light which is reddish, the red pixel will be set to a lower gain than the blue pixel, so that any blue present in the scene is amplified to compensate for the red bias. For fluorescent light, to offset the green bias, red and blue are both set to higher gain. This can be done by varying pixel voltage, and is called analog white balance, which can be done to the camera before image capture.

AWB can also be done digitally, by taking the R₁G₁B₁ values from the camera sensor and recomputing R₂G₂B₂ as linear combinations of R₁G₁B₁, to correct for the color bias, where:

R₂=C₁₁R₁+C₁₂G₁+C₁₃B₁

G₂=C₂₁R₁+C₂₂G₁+C₂₃B₁

B₂=C₃₁R₁+C₃₂G₁+C₃₃B₁

The matrix:

$$( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} )$$

can be known as the color correction matrix. This step can also be used to make the colors more pleasing and appropriate to cultural preferences beyond compensating for the illuminant.

AWB can involve using both analog and digital methods. The analog method can be applied before capture, and the digital method can be applied during or after capture. As an example, some cameras may use both, while some others may use only one of the two.

Accordingly, among other benefits, the teachings of the present disclosure can be used in limited light mobile imaging systems, where computational ability may prevent the employment of complex algorithms for auto white balance. Also, when mobile imaging systems have two cameras that face different directions the teachings of the present disclosure can help achieve better auto white balance. Thus, the enclosed teachings may be useful as mobile phones with two cameras become popular. This can be useful when a single device is used most of the time by the same person so a specific skin tone may be pre-programmed to achieve a high degree of accuracy. Alternately, a known gamut of skin tones may be used. The enclosed teachings may also be useful because mobile device imaging systems are different from conventional digital still cameras due to low light and lack of computing resources.

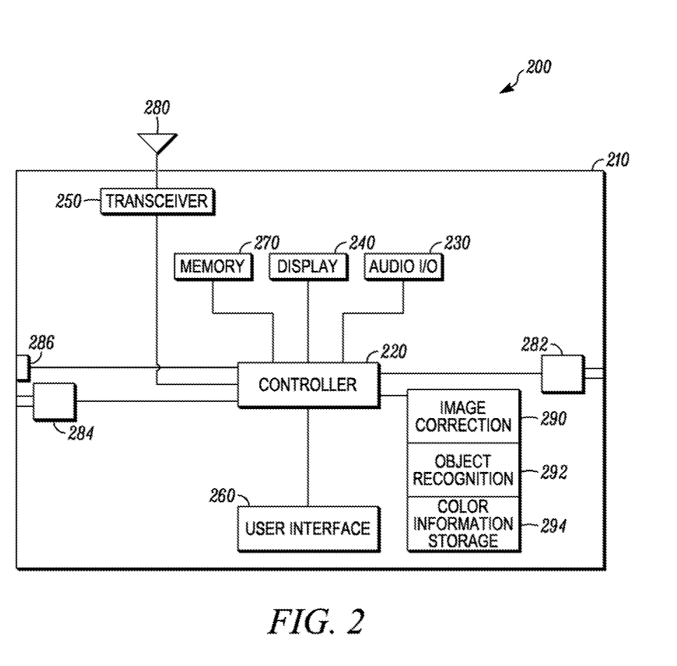

FIG. 2 is an exemplary block diagram of a wireless communication device 200, such as the device 100, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The wireless communication device 200 can also include a first camera 282, a second camera 284, and an optical viewfinder 286.

The wireless communication device 200 can additionally include an image correction module 290, an object recognition module 292, and a color information storage module 294. The image correction module 290, the object recognition module 292, and the color information storage module 294 can be coupled to the controller 220, can reside within the controller 220, can reside within the memory 270, can be autonomous modules, can be software, can be hardware, or can be in any other format useful for a module on a wireless communication device 200.

The wireless communication device 200 can be a selective call receiver, such as a wireless telephone, a cellular telephone, a personal digital assistant, a pager, a personal computer, or any other device that is capable of sending and receiving communication signals on a network including wireless network. For example a wireless network can be a wireless wide area network such as a wireless telecommunications network, a cellular telephone network, a Time Division Multiple Access (TDMA) network, a Code Division Multiple Access (CDMA) network, a satellite communications network, and other like communications systems.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a wireless communication device.

In operation, the first camera 282 can capture a first image and the second camera 284 can capture a second image. The image correction module 290 can set a white balance of the first camera 282 based on the second image captured by the second camera 284. For example, the second image can be an image of a user of the device captured by the second camera 284. The object recognition module 292 can identify an object of a known color based on the second image captured by the second camera 284 and the image correction module 290 can set a white balance of the first camera 282 based on the object of a known color. The object recognition process can be independent of the color in the object and/or independent of the processes performed by the other modules. The image correction module 290 can then set a white balance of the first camera 282 based on skin color information in the object of a known color. For example, the object of a known color can be a face of a user using the device. The color information storage module 294 can store skin color information and the image correction module 290 can set a white balance of the first camera 282 based on the skin color information. For example, skin color information can be stored as numerical data, and not necessarily as an image. For example, average Red, Green, Blue (RGB) values or brightness and color (L,a,b) values representing skin color information can be stored in the color information storage module 294 or in the memory 270 by using the color information storage module 294.

The second camera 284 can face a substantially opposite direction of the first camera 282. A viewfinder can face substantially in the same direction as the second camera 284. For example, the viewfinder can be the optical viewfinder 286 or the display 240. Thus, if the wireless communication device 200 is a cellular phone, the user can use the display 240 as a viewfinder to capture a first image using the first camera 282. In the process of capturing the first image, the second camera 284 can capture a second image. The second image can be used to adjust the white balance of the first camera and/or the first image.

The terms “first” and “second” and other similar terms are only used as labels and do not necessarily connote a temporal relation between the labeled elements. Thus, the timing of capturing the first and second image may be switched or may be simultaneous. For example, the first image may be captured by the first camera 282 after the second image is captured by the second camera 284 or vice versa.

According to a related embodiment, the wireless communication device 200 can be a selective call receiver. The wireless communication device 200 can include a housing 210, a transceiver 250 coupled to the housing, a first camera 282 coupled to the housing, a second camera 284 coupled to the housing, a controller 220 coupled to the transceiver 250, the first camera 282, and the second camera 284, an object recognition module 292 coupled to the controller 220, and an image correction module 290 coupled to the controller 220.

In operation the transceiver 250 can send and receive wireless wide area network communication signals. The first camera 282 can capture a first image. The second camera 284 can capture a second image. The controller 220 can control the operations of the wireless communication device 200. The object recognition module 292 can identify a specific object in the second image captured by the second camera. The image correction module 290 can then set a white balance of the first image captured by the first camera 282 based on color information corresponding to the specific object in second image captured by the second camera 284. For example, the image correction module 290 can set a white balance of the first camera 282 based on skin color information corresponding to the specific object in second image captured by the second camera 284. The specific object in the second image can be a user of the device and the second camera 284 can capture the second image including the user of the device. The specific object may be a face of a user using the device. The wireless communication device 200 can include a color information storage module 294 configured to store skin color information of the user or other skin color information. The image correction module 290 can then set a white balance of the image captured by the first camera 282 based on the skin color information. For example, the image correction module 290 can compare the stored skin color information regarding with information regarding the skin color of a user in the image captured by the second camera 284. The image correction module 290 can then set a white balance of the image captured by the first camera 282 based on this comparison.

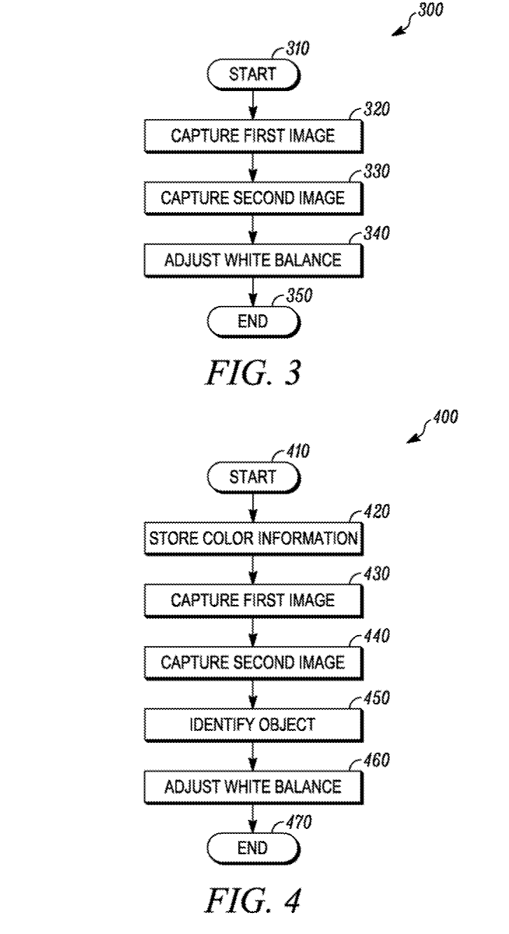

FIG. 3 is an exemplary flowchart 300 illustrating the operation of the wireless communication device 200 according to one embodiment. In step 310, the flowchart begins. In step 320, the wireless communication device 200 can capture a first image using a first camera 282. In step 330, the wireless communication device 200 can capture a second image using a second camera 284. In step 340, the wireless communication device 200 can adjust a white balance of the first image captured by the first camera 282 based on the second image captured by the second camera 284. In step 350, the flowchart 300 can end.

The white balance sequence can be implemented in multiple ways. Thus, the first image may be captured then the second image, and then the object recognition part. Then digital white balance can be done using the color correction matrix described above. As an example of a different sequence, the second image can be captured and the required color correction can estimated. This can be used to do analog white balance by varying the voltage gain on the camera pixels as described above. The first image can then be captured, and further digital white balance can be performed based on the estimated color correction. Additionally, a mix of analog and digital white balancing can be used to produce possibly better quality images. Analog white balance is typically used when the second image capture happens before the first image capture. In other situations only digital white balance is done, which can be independent of the image capture sequence.

FIG. 4 is an exemplary flowchart 400 illustrating the operation of the wireless communication device 200 according to another embodiment. In step 410, the flowchart begins. In step 420, the wireless communication device 200 can store skin color information. In step 430, the wireless communication device 200 can capture a first image using the first camera 282. In step 440, the wireless communication device 200 can capture a second image using the second camera 284. The second image can be an image of a user of the device and capturing a second image can include capturing the second image of the user of the device. In step 450, the wireless communication device 200 can identify an object of a known color based on the second image captured by the second camera 284. In step 460, the wireless communication device 200 can adjust a white balance of the first image captured by the first camera 282 based on the second image captured by the second camera 284. The wireless communication device 200 can adjust the white balance of the first image captured by first camera 282 based on the object of a known color. The wireless communication device 200 can also adjust a white balance of the first image captured by the first camera 282 based on skin color information in the object of a known color. The object of a known color can be a face of a user using the device. The wireless communication device 200 can adjust a white balance of the first image captured by the first camera 282 based on information regarding skin color information of the user. In step 450, the flowchart 400 can end.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A device, comprising:
a housing;
a first camera coupled to the housing, the first camera configured to capture a first image;
a second camera coupled to the housing, the second camera configured to capture a second image;
a controller coupled to the first camera and the second camera, the controller configured to control the operations of the device; and
an image correction module coupled to the controller, the image correction module configured to set a white balance of the first image based on the second image captured by the second camera.

2. The device according to claim 1,
wherein the second image comprises an image of a user of the device, and
wherein the second camera is configured to capture the second image of the user of the device.

3. The device according to claim 1, further comprising an object recognition module configured to identify an object of a known color based on the second image captured by the second camera,
wherein the image correction module is configured to set a white balance of the first image based on the object of a known color.

4. The device according to claim 3, wherein the image correction module is configured to set a white balance of the first image based on skin color information in the object of a known color.

5. The device according to claim 3, wherein the object of a known color comprises a face of a user using the device.

6. The device according to claim 5, further comprising a color information storage module configured to store skin color information,
wherein the image correction module is configured to set a white balance of the first image based on skin color information.

7. The device according to claim 1, wherein the second camera faces in a substantially opposite direction of the first camera.

8. The device according to claim 7, further comprising a viewfinder that faces substantially in the same direction as the second camera.

9. A method for capturing an image, comprising:
capturing a first image using a first camera;
capturing a second image using a second camera; and
adjusting a white balance of the first image captured by the first camera based on the second image captured by the second camera.

10. The method according to claim 9,
wherein the second image comprises an image of a user of the device, and
wherein capturing a second image comprises capturing the second image of the user of the device.

11. The method according to claim 9, further comprising:
identifying an object of a known color based on the second image captured by the second camera,
wherein adjusting comprises adjusting a white balance of the first image captured by first camera based on the object of a known color.

12. The method according to claim 11, wherein adjusting comprises adjusting a white balance of the first image captured by the first camera based on skin color information in the object of a known color.

13. The method according to claim 11, wherein the object of a known color comprises a face of a user using the device.

14. The method according to claim 13, further comprising storing information regarding skin color,
wherein adjusting comprises adjusting a white balance of the first image captured by the first camera based on the information regarding skin color.

15. The method according to claim 9, wherein the second camera faces in a substantially opposite direction from the first camera.

16. A selective call receiver, comprising:
a housing;
a transceiver coupled to the housing, the transceiver configured to send and receive wireless wide area network communication signals;
a first camera coupled to the housing, the first camera configured to capture a first image;
a second camera coupled to the housing, the second camera configured to capture a second image;
a controller coupled to the transceiver, the first camera, and the second camera, the controller configured to control the operations of the selective call receiver;
an object recognition module coupled to the controller, the object recognition module configured to identify a specific object in the second image captured by the second camera; and
an image correction module coupled to the controller, the image correction module configured to set a white balance of the first image based on color information corresponding to the specific object in second image captured by the second camera.

17. The selective call receiver according to claim 16, wherein the image correction module is configured to set a white balance of the first image based on skin color information corresponding to the specific object in second image captured by the second camera.

18. The selective call receiver according to claim 17,
wherein the specific object in the second image comprises a user of the device, and
wherein the second camera is configured to capture the second image including the user of the device.

19. The selective call receiver according to claim 18, wherein the specific object comprises a face of a user using the device.

20. The selective call receiver according to claim 19, further comprising a color information storage module configured to store information regarding skin color information of the user,
wherein the image correction module is configured to set a white balance of the first image based on information regarding skin color information of the user.
